(19) United States
(12) Patent Application Publication
(10) Pub. No.: US 2007/0079309 A1
(43) Pub. Date: Apr. 5, 2007

(54) Task generation using information handling system

(76) Inventors: David Schmidt, Round Rock, TX (US); Timothy Abels, Pflugerville, TX (US)

Correspondence Address: HAMILTON & TERRILE, LLP, P.O. BOX 203518, AUSTIN, TX, 78720, US

(21) Appl. No.: 11/240,722

(22) Filed: Sep. 30, 2005

(51) Int. Cl. G06F 9/46

(52) U.S. Cl. 718/100

(57) ABSTRACT

A system and method for generating sequences of manual operations, using a structured process and grammar, suitable for implementation in systems integration. The method of the invention allows manual operations can be defined locally, or by remote subject matter experts (SMEs), using a Manual Operations Grammar, with the system allowing the definition of methods for validating measurements, reporting, and optimizing a set of one or more operations and/or processes. As part of the grammar, formalized hooks can be implemented between a plurality of manual tasks, operation and/or process steps, and a plurality of automated tasks, operation and/or process steps.

### BACKGROUND OF THE INVENTION

1. Field of the Invention

The present invention relates in general to the field of information handling systems, and more specifically, to a method and apparatus for generating scripts for the management of manual tasks, operations or processes.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes, thereby allowing users to take advantage of the value of the information. Because technology and information handling needs and requirements vary between different users or applications, information handling systems may also vary regarding what information is processed, stored or communicated, an how quickly and efficiently the information may be processed, stored, or communicated. The variations in information handling systems allow for information handling systems to be general or configured for a specific user or specific use such as financial transaction processing, airline reservation, enterprise data storage, or global communications. In addition, information handling systems may include a variety of hardware and software components that may be configured to process, store, and communicate information, and may include one or more computer systems, data storage systems, and networking systems.

The ongoing management of these systems can become problematic as they proliferate in number and the business operations they are used in become more complex. Exacerbating the situation is the fact that not all operations and/or processes can be completely automated and may require one or more manual actions by a human operator. Some of these operators may possess less than optimal qualifications and/or speak different languages, further complicating the situation. While there are some standardized languages for process management, there is no common grammar between automated and manual operations and/or processes. For example, Business Process Execution Language (BPEL), Orchestration, and similar automation approaches have neither a grammar for manual steps, nor formalized hooks between manual steps and automated steps.

Currently, manual steps are not formalized by a grammar capable of driving operations and/or processes such as auditing, validation, integration with automated steps, remote access, or reusable scripts. There is a need, therefore, for a system and method for implementing grammar-driven scripts for the optimization of manual operations and/or processes. In particular, there is a need for a system and method that can implement such scripts based on known cost-reduction capabilities, quality metrics, task localities, completion times, and/or policies, coupled with the ability to leverage remote expertise, such as subject matter experts.

### SUMMARY OF THE INVENTION

In accordance with the present invention, a system and method is disclosed for a grammar-driven approach to operations and integration, combined with a run-time engine and/or environment. The present invention makes it possible to reduce the staffing required to perform manual tasks, operations, and/or processes in information technology (IT) operations, data centers, or other operations that require one or more manual actions by human operators.

In the present invention, a process management protocol is implemented based on grammar, such as that used in the flexible construct of a sentence. The Manual Operations Grammar, described in more detail hereinbelow, allows local or remote Subject Matter Experts (SMEs) to formalize manual steps for a task, process and/or operation, in an unambiguous, reusable, and auditable manner. Furthermore, the present invention makes it possible to integrate these steps with automated tasks, processes and/or operations.

In one embodiment of the invention, a remote SME lab has a local break-fix staff install boot CDs in a plurality of information handling systems (e.g., servers), then remotely and automatically continue the validation and set-up of each system. In various embodiments of the invention, many associated elements of the method are “grammar driven,” including the integration between manual and automated tasks, processes and/or operations. These tasks, processes and/or operations can include security access levels, audit sign-off, reporting of time stamps, audits, and success/failure events, as well as task dependencies potentially affecting allowable optimizations.

Those of skill in the art will understand that many such embodiments and variations of the invention are possible including, but not limited to, those described hereinabove.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 is a generalized illustration of an information handling system that can be used to implement the system and method of the present invention.

FIG. 2 is a flowchart illustrating an integrated manual and automated operations control system in accordance with one embodiment of the present invention.

FIG. 3 is a flowchart illustrating an integrated manual and automated operations control system in accordance with another embodiment of the present invention.

### DETAILED DESCRIPTION

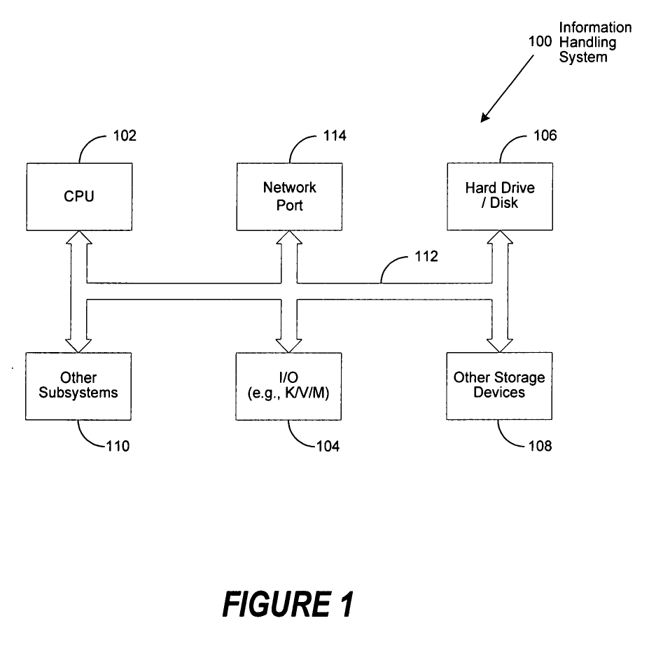

FIG. 1 is a generalized illustration of an information handling system 100 that can be used to implement the method and apparatus of the present invention. The information handling system includes a processor 102, input/output (I/O) devices 104, such as a display, a keyboard, a mouse, and associated controllers, a hard disk drive 106, other storage devices 108, such as a floppy disk and drive and other memory devices, various other subsystems 110, and network port 114, all interconnected via one or more buses 112.

For purposes of this disclosure, an information handling system may include any instrumentality or aggregate of instrumentalities operable to compute, classify, process, transmit, receive, retrieve, originate, store, display, manifest, detect, record, reproduce, handle, or utilize any form of information, intelligence or data for business, scientific, control or other purposes. For example an information handling system may be a personal computer, a network storage device, or any other suitable device and may vary in size, shape performance, functionality, and price. The information handling system may include random access memory (RAM), one or more processing resources such as a central processing unit (CPU) or hardware or software control logic, read only memory (ROM), and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

As was discussed above, the ongoing management of these systems can become problematic as they proliferate in number and the business operations they are used in become more complex. In particular, the management of information handling systems in some environments is complicated by the fact that there is no common grammar for use in process management languages to integrate automated and manual operations and/or processes.

The present invention provides a method and system wherein a management process can be implemented based on the flexible construct of a sentence. Those of skill in the art will recognize that sentences are flexible because language recognizes cohesion. For example, there may be no obvious similarity or function between elements of a sentence, yet they can be interchangeably combined, based on rules of grammar. The Manual Operations Grammar, described in more detail hereinbelow, allows local or remote Subject Matter Experts (SMEs) to use grammar to formalize manual steps for a task, process and/or operation and to integrate these steps with automated tasks, processes and/or operations. These tasks, processes and/or operations can include security access levels, audit sign-off, reporting of time stamps, audits, and success/failure events, as well as task dependencies potentially affecting allowable optimizations.

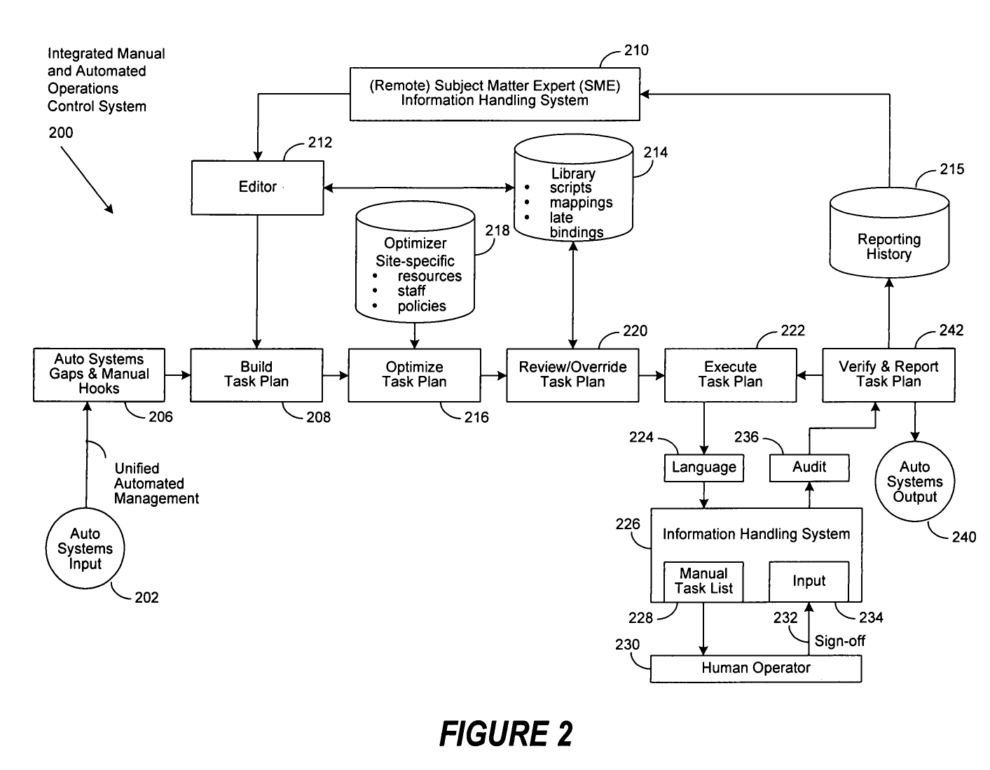

FIG. 2 is a flowchart illustration of an implementation of an integrated manual and automated operations control system 200 in accordance with one embodiment of the present invention. The various process steps and functional modules can be implemented using one or more information handling systems using techniques understood by those of skill in the art. In this embodiment of the invention, a process and associated grammar is implemented to remotely control a sequence of manual and automated operations. Manual operations are defined using an operation grammar, and the process defines methods for validating, measuring, reporting, and optimizing a set of operations.

In one implementation of this embodiment of the invention, automated tasks, operations, and/or processes, representing a unified and automated management system, are entered in by an auto systems input 202 that can be implemented using an information handling system. In various embodiment of the invention, these same automated tasks, operations, and/or processes, can be represented by high-level scripts.

In step 206, predetermined gaps in the automated management system are identified, and hooks for manual operations are established and defined. In step 208, a task plan is built by merging and/or integrating a plurality of automated scripts and/or tasks with a plurality of manual scripts/tasks. In one embodiment of the invention, a human operator can perform the actions in this step locally.

In various embodiments of the invention, a remote human operator such as a subject matter expert (SME) using the remote SME information handling system 210, can access a library 214 containing scripts for both automated and manual operations, as well as mapping and late binding information which can be used in conjunction with an editor 212 to perform these same steps. The resulting script becomes a sequence of automated and manual tasks with late binding, which allows linking to, and/or invocation of, current versions of validations, best practices, and policies. Once the automated script portions of the task plan have been verified, manual tasks can be added, which can then be verified for proper operation.

Upon verification, the resulting script can be subdivided into tasks and runtime hooks for manual operations can be added. In various embodiments of the invention, metadata tags may be added to the scripts including, but not limited to, dependency tasks (e.g., for optimization passes on task grammar), estimated time to complete, and predetermined skill required (e.g., for who and sign-off). In addition, metadata tags may be added for launch schedule (e.g., time, recurrence frequency such as daily, weekly, etc., or launch event), and priority levels (e.g., urgent problem management, cost-benefit change management, low priority maintenance, etc.). Upon completion and successful validation, the resulting script can be added to the library 214.

In Step 216, the task plan can be optimized by an optimizer module 218. In one embodiment of the invention, a hybrid dependency graph can be generated, providing a topological sort of all fixed dependencies between tasks. In other embodiments of the invention, large-scale automated management systems may require a pre-pass at script-level, followed by task-levels within scripts. Optimization passes can be based on an optimal match based on fixed criteria (e.g., physicals, regulations, staff skills, max staffing) and/or weighted policies (cost, staff, off-peak, time).

In one embodiment of the invention, the optimizer 218 comprises a dependency engine that is operable to optimize the sequence of operations, allowing manual operations to be combined when feasible. These manual operations can then be performed in large blocks, thereby optimizing the use of human operators performing manual operations. As an example, optimization choices can include references to physical resources, time (e.g., three 5-minute tasks combined to create a worthwhile task block), recurrence level (e.g., daily, weekly, etc.), and priority level.

In step 220, the task plan can be reviewed by displaying scripts, mappings, binding info etc., and if required, manually overridden for out-of-band errors, advanced knowledge of the execution environment, or other possible error situations. Those of skill in the art will appreciate that automated or manual matches to existing manual scripts can allow skipping some or all of the steps and sub-steps comprising step 208 and step 216, but late binding steps as described in step 220 cannot be omitted. In step 222, the task plan is executed by queuing the highest-priority, non-blockable task list, which is defined as a trade-off between automated and manual operations. In step 224, the tasks are personalized (e.g., skill, language, localization, etc.) before they are presented as a manual task list 228 on the display of an information handling system 226 used by a human operator 230.

The human operator 230 then executes the tasks, operations and/or processes listed in the manual task list 228 and sign-off information 232 is entered as input 234 to an information handling system 226. The entered sign-off information 232 is audited in step 236 before being verified in step 242. In step 242, the verified and reported task plan can be presented for re-execution in step 222, presented as automated system output to an information handling system (e.g., as input to another system) 240, or stored as reported history 215, which can be presented and/or reviewed by a SME using a remote SME information handling system 210. As an example, reporting can include but is not limited to, the tracking of manual and automation metrics, estimated time versus defined time-per-tasks, signoff auditing, as well as failure, warning, and message logs.

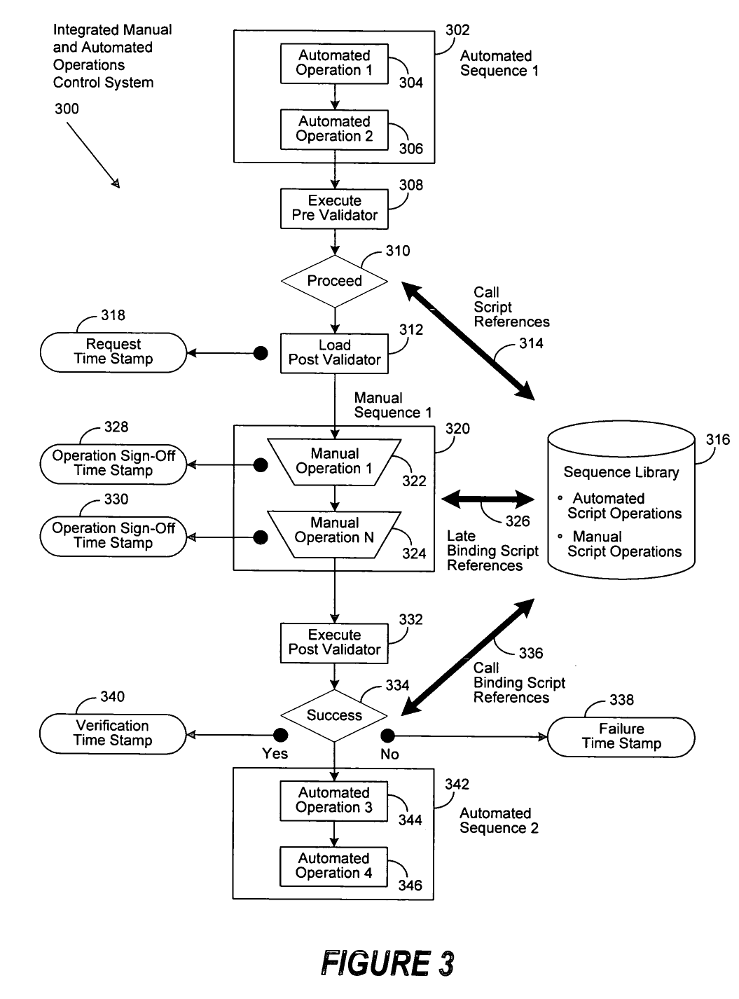

FIG. 3 is a flowchart illustration of another implementation of an integrated manual and automated operations control system 300 in accordance with one embodiment of the present invention. In this embodiment of the invention, a first sequence of automated operations 302, comprised of a first automated operation 304 and a second automated operation 306, is initiated. In step 308, a pre-validator process is executed, which in step 310, calls script references 314, which reside in sequence library 316. After script references 314 are called from sequence library 316 as required, they are validated and loaded in step 312. Upon validation and loading, a time stamp may be requested and generated by the operations control system in step 316.

Next, a first sequence of manual operations 320, comprised of a first manual operation 322, through N number of manual operations 306, is initiated, in accordance with scripts previously retrieved from sequence library 316. As will be apparent to those of skill in the art, the root Manual Operations Grammar unit called by an operations control system or subject matter expert (SME), is in the form of a script, implementing syntax as illustrated in the samples hereinbelow.

Sample 1:
//Script—root integration with automated systems of SME Library invocations script: preload_auto_validation control_statements script_library auto_validation_callback
preload_auto_validation: //see callback syntax (such as Python's)for registering callback handlers
auto_validation_callback: //invoke callback to auto. Callback types include transactional,
//connection, exception, event-specific or no-op for synchronous

Sample 2:
//metadata info for maintaining script in Library script_library: library version signoff_level launch_frequency est_completion_time
version: major_num ‘.’ Minor_num ‘.’ Build_num
launch_frequency: one
one_time_launch: once|daily|weekly
est_completion_time: hours_num|minutes_num|seconds_num
signoff_level: tech|lab_engineer|sr_lab_engineer //or specific skills
priority_level: high|medium|low|num

Sample 3:
//Control statements of manual tasks
control_statements: FOR expression DO control_statements ENDFOR
   |WHILE expression DO control_statements ENDWHILE
   |IF expression THEN control_Statements ELSE control_statements ENDIF
   |optional_who manual_task_list optional_signoff
espression: //Boolean values and operators
manual_task_list: manual_task_list manual_task
   |//empty
manual_task: io_task io_object
   |system_task optional_system_context_system_object u_location
   |connect_task connect_object connection_length
   |//empty

Sample 4:
//Data center sample of manual tasks, could extend for IT desktop, FRU support, etc.
optional_who: names|roles|//empty if default
optional_signoff: password|map_to_password|//empty if default
io_task: PUT|LABEL|RETURN
io_object: tape|usb|cd|dvd
system_task: BUILD|TEARDOWN|REBOOT|SHUTDOWN
optional_system_context: rack ‘.’ chassis ‘.’|rack ‘.’|chassis ‘.’|//empty if default
system_object: server|storage|ups|switch|router
connect_task: PLUG|UNPLUG
connect_object: cable|power|cooling
connect_num: num //cable, power, or cooling number
connection_length: num
cable: ETHERNET|FAST_ETHERNET_GIG_ETHERNET|FIBER_CHANNEL|FAST_FIBER_CHANNEL|INFINIBAND|slot_num port_num|BOARD port_num
power: POWERSUPPLY
cooling: FAN
u_location: unum ‘−’ u_num|u_num //iff 1U
tape: TAPE num
usb: USB num
cd: CD num|CD_VariableName //late binding name like WIN2003EE_CURRENT_CD
dvd: DVD num
rack: RACK num
chassis: CHASSIS num
U_num: num //1 to 42 only
Num: [0123456789]+

Prior to execution of the first manual sequence 320, late binding script references 326, which allow linking to and/or invocation of, current versions of physicals (e.g., current CD version), validations, best practices, and policies, are accessed from sequence library 316. Concurrently, the operations control system may request a time stamp 328, 330, whenever a late binding script reference is associated with each manual operation 322, 324 of the first manual sequence 320. In step 332, the post validator process is executed to check the validity of the scripts comprising the first manual sequence 320.

If, in step 334, validity checks are verified to be successful, a verification time stamp may be generated in step 340, before proceeding to the second automated sequence 342, comprised of a third automated operation 344 and a fourth automated operation 346. If, in step 334, validity checks fail, and are verified to not be successful, binding script references can be called 336 from sequence library 316 and associated with a failure time stamp 338.

Those of skill in the art will realize that various embodiments of the invention are not limited to integration of automated and manual task lists, the sample grammar as illustrated hereinabove, or maintenance of information handling systems. Furthermore, the grammar-driven integration described herein can enable manual tasks, processes and/or operations for IT desktops, field ready units, service installations (e.g., phone, cable), or any series of tasks, operations and/or processes that may include the management of manual actions by human operators. Skilled practitioners in the art will recognize that many other embodiments and variations of the present invention are possible. In addition, each of the referenced components in this embodiment of the invention may be comprised of a plurality of components, each interacting with the other in a distributed environment. Furthermore, other embodiments of the invention may expand on the referenced embodiment to extend the scale and reach of the system's implementation.

At a minimum, the present invention provides a system and method for a grammar-driven approach to operations and integration, combined with a run-time engine and/or environment, which can reduce the staffing required to perform manual tasks, operations, and/or processes in information technology (IT) operations, data centers, or other operations environments that use information handling systems requiring one or more manual actions by human operators. Furthermore, human operator staff may not require as much skill, or a common native language when using an implementation of various embodiments of the invention. In addition, implementation of the invention can enable cost reductions that include staffing, training, automated reporting, service times, mean time to recovery (MTTR), and off-peak utilization. Similarly, use of the invention can facilitate quality improvements that include removing ambiguity, task-based sign-off, improved error rates, auditability, complete reporting, shortened service times, enhanced safety, and mean time to recover (MTTR).

1. A system for generating a sequence of manual instructions, comprising:
an information handling system operable to generate a task plan;
a library comprising a plurality of scripts corresponding to processes in said task plan; and
an editor operable to select scripts from said library and to provide said scripts to said information handling system for incorporation into said task plan.

2. The system of claim 1, wherein said editor is controlled by a remote information handling system.

3. The system of claim 2, wherein said scripts define predetermined relationships between manual processes and automated processes.

4. The system of claim 3, wherein said scripts incorporate late binding information.

5. The system of claim 4, wherein said scripts comprise metadata tags.

6. The system of claim 5, wherein said metadata tags comprise dependency tasks.

7. The system of claim 5, wherein said metadata tags comprise priority levels.

8. The system of claim 1, further comprising an optimizer operable to combine predetermined scripts using a dependency engine.

9. The system of claim 8, wherein said scripts are optimized by generating a topological sort of fixed dependencies between tasks.

10. The system of claim 9, wherein execution of tasks related to said scripts are monitored using a reporting history module.

11. A method for generating a sequence of manual instructions, comprising:
using an information handling system to generate a task plan;
obtaining a plurality of scripts from a library, said scripts corresponding to processes in said task plan; and
using an editor to select scripts from said library and to provide said scripts to said information handling system for incorporation into said task plan.

12. The method of claim 11, wherein said editor is controlled by a remote information handling system.

13. The method of claim 12, wherein said scripts define predetermined relationships between manual processes and automated processes.

14. The method of claim 13, wherein said scripts incorporate late binding information.

15. The method of claim 14, wherein said scripts comprise metadata tags.

16. The method of claim 15, wherein said metadata tags comprise dependency tasks.

17. The method of claim 15, wherein said metadata tags comprise priority levels.

18. The method of claim 11, further comprising an optimizer operable to combine predetermined scripts using a dependency engine.

19. The method of claim 18, wherein said scripts are optimized by generating a topological sort of fixed dependencies between tasks.

20. The method of claim 19, wherein execution of tasks related to said scripts are monitored using a reporting history module.
